(19) United States
(12) Patent Application Publication
(10) Pub. No.: US 2007/0176515 A1
(43) Pub. Date: Aug. 2, 2007

(54) Stator and Carriage for a Piezoelectric Liner Motor

(75) Inventors: Yung Ting, Tao-Yuan (TW); Liang-Chiang Chen, Tao-Yuan (TW); Chun-Chung Li, Tao-Yuan (TW); Jian-Lin Huang, Tao-Yuan (TW); Chieh-Min Yang, Tao-Yuan (TW)

Correspondence Address: WPAT, PC, 7225 BEVERLY ST., ANNANDALE, VA, 22003, US

(73) Assignee: CHUNG YUAN CHRISTIAN UNIVERSITY, Tao-Yuan (TW)

(21) Appl. No.: 11/610,475

(22) Filed: Dec. 13, 2006

Related U.S. Application Data
(60) Provisional application No. 60/762,508, filed on Jan. 27, 2006.

(51) Int. Cl. H02N 2/00

(52) U.S. Cl. 310/332

(57) ABSTRACT

A piezoelectric linear motor apparatus and method is provided. The apparatus comprises a carriage configured to be actuated and a stator configured to actuate the carriage. The stator comprises a meander line structure and a gear teeth structure, coupled to the top of the meander line structure and a contact layer underneath the carriage. Furthermore, the meander line structure comprises a series of bimorph actuators laid linearly in the meander line structure. Each pair of neighboring bimorph actuators being linked with a corresponding connector on both sides of top and bottom. The meander line structure also comprises an odd series of connectors and an even series of connectors, interleaved with each individual connector, applied with phase-splitter's alternating current (AC) power to deform the bimorph actuators for generating traveling wave. The gear teeth structure is configured to transport traveling wave from the meander line structure to the carriage.

### BACKGROUND OF THE INVENTION

1. Field of the Invention

This invention generally relates to the field of the liner motors, and more particularly, to a stator and a carriage for a piezoelectric liner motor and the design methods thereof.

2. Description of the Prior Art

In general, a bimorph actuator is composed of two thin panels of ceramic elements bonded together with a flexible metallic panel as it's central electrode. By wiring these two elements in such a way as to make one elongate and the other contract by applying voltage, inflection deviation occurs conforming to the waveform of the applied voltage. This allows it to be used as an actuator.

In the recent decades, many researches on various types of piezoelectric motor have been investigated. Fundamentally, according to the vibration mode, piezoelectric motor can be categorized into single mode and multi-mode. Two main types, the rotary ultrasonic motor as a single mode and the linear piezoelectric motor as a double mode are popular seen and used in the industries. The former one is driven by traveling wave, and Sashida developed a first traveling-wave ultrasonic motor in 1982. The latter one is driven by a combination of the longitudinal and bending vibration modes, and Tomikawa et al. developed a linear motor in 1992.

Regarding the traveling-wave type of ultrasonic motor, Ueha and Kurosawa developed an ultrasonic rotary motor in 1988. Piece to piece of piezoelectric ceramics connected with different and complementing (positive and negative) driving phases next to each other in a circle generate traveling wave, which moves the above rotor with an effective displacement. In 1990, Segawa et al. built a circular shape of ultrasonic motor with five positive and negative poles next to each other driven by two voltage resources with 90° phase difference. The stator generated elliptical motion to drive the rotor. The speed could reach 200 rpm and the maximum torque could reach 3 kgf.cm. In 1995, Krome et al. studied the dynamic behavior of the stator by finite element method, whose efficiency is influenced by the geometry of the ceramic actuators as well as the stiffness of the bonding layer. In 2000, Maas designed a disc-type ultrasonic motor that could generate torque 0.2 Nm at speed of 10 rpm. In 2002, Zhao et al. used finite element method to analyze the performance of disc-type ultrasonic motor. Simulations by ANSYS with respect to various frequencies were investigated to derive the relation between the angle and the axial displacement. In 2003, Pons, et al. proposed a fast and accurate method for modeling the ultrasonic motor. By use of the Ritz method, an approximate solution with better accuracy is obtained from the dynamic model.

The meander-line structure proposed by Robbins et al. in 1990 was used for positioning. It consists of a series of stack-type piezoelectric actuators in connection with the connectors in between. Through a DC power source in the center of the structure, which would have the largest output, is used for positioning.

In 1991, Kurosawa and Ueha is probably the first one to investigate the friction problem between the rotor and the stator. Linearization model was used to analyze the deformation of the rotor, to calculate the toque and the speed, and to evaluate the performance. Maeno et al. used the finite element method to carry on comprehensive study on the deformation of the contact layer. Experiments were done to verify the analytical result. The torque-speed relation, power loss, and so on was discussed, too. In 1995, Hagood et al. built a simulation framework for the stator and rotor of ultrasonic motor. The emphasis on the interface between the stator and rotor can clearly show the contact force is determinative to the output performance of the motor. In 1995, Hirata et al. established a design method for ultrasonic motor. The method consists of two models. A two-dimensional elastic contact model is used for the estimation on the friction between the driving stator and the rotor. Another model is based on an electrical equivalent circuit that is used for the estimation on the interaction between the electrical and mechanical part of the motor.

In 1996, Schmidt et al. used a simplified model on the assumption of the stator as a Bernoulli-Euler beam and rotor as a rigid body and contact layer as visco-elastic material to analyze the contact behavior of a traveling-wave ultrasonic linear motor, and evaluate the loss due to contact effect. In 1997, Moal et al. investigated the dynamic contact mechanism of the ultrasonic motor and the deflection effect of the contact layer while the rotor encountered axial preload. The motor performance could be estimated with the input of contact ratio, axial preload, amplitude of traveling wave, and relative geometry of the motor. In 2004, Bai et al. proposed a new method to control the rotation speed of the ultrasonic motor by means of the difference between the driving frequencies. The rotation speed is verified in experiment to be equal to the phase-velocity difference between the stator and the rotor.

Summarized from the lengthy description of developments in the latest two decades, there exist some needs for improving the conventional linear piezoelectric motor generated by traveling wave.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

A piezoelectric linear motor driven by bimorph actuator is developed. The stator fundamentally consists of a meander-line structure and a gear teeth mounted on the meander-line structure is focused in the present invention. The meander-line structure with bimorph actuators in a line driven by two sets of AC power with phase difference can generate traveling wave. The traveling wave is transferred to the carriage by the gear teeth, and thus forms a linear motor. Modeling of the meander-line structure is derived.

In the present invention, carriage design of a piezoelectric linear motor driven by bimorph actuator is investigated. Traveling wave is created by stator, which is constructed by a series of bimorph actuators laid in line and connected by connectors to form a meander-line structure. Based on the stator mentioned above, the structure and modeling as well as performance analysis of the carriage is focused in the present invention. In the present invention, the carriage design and analysis of a new type of linear piezoelectric motor generated by traveling wave is studied. The structure, modelling, and performance evaluation is addressed, and some design issues are simulated by ANSYS.

In one embodiment, a piezoelectric linear motor apparatus is provided. The apparatus comprises a carriage configured to be actuated and a stator configured to actuate the carriage. The stator comprises a meander line structure and a gear teeth structure, coupled to the top of the meander line structure and a contact layer underneath the carriage. Furthermore, the meander line structure comprises a series of bimorph actuators laid linearly in the meander line structure. Each pair of neighboring bimorph actuators being linked with a corresponding connector on both sides of top and bottom. The meander line structure also comprises an odd series of connectors and an even series of connectors, interleaved with each individual connector, applied with phase-splitter's alternating current (AC) power to deform the bimorph actuators for generating traveling wave. The gear teeth structure is configured to transport traveling wave from the meander line structure to the carriage.

In another embodiment, a method for actuating a carriage is disclosed. At first, providing a meander line structure coupled to a gear teeth structure underneath the carriage. The meander line structure further comprises a series of bimorph actuators laid linearly in the meander line structure. Each pair of neighboring bimorph actuators being linked with a corresponding connector on both sides of top and bottom. The meander line structure further comprises an odd series of connectors and an even series of connectors, interleaved with each individual connector. Secondly, deforming the bimorph actuators by applying phase-splitter's alternating current (AC) power to the odd and the even series of connectors. At last, transporting traveling waves, generated by the deforming, to the carriage via the gear teeth structure.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1A illustrates the configuration of a linear motor of one embodiment in accordance with the present invention;

FIG. 1B illustrates the configuration of a stator of another embodiment in accordance with the present invention;

FIG. 2 illustrates the configuration of a series of bimorph actuators laid linearly in the meander line structure;

FIG. 3 illustrates the bimorph as a cantilever beam of another embodiment in accordance with the present invention;

FIG. 4 illustrates the equal bent-up and bent-down effect; and

FIG. 5 illustrates the wave transmission to the carriage.

### DETAILED DESCRIPTION OF THE PREFERRED EMBODIMENTS

Some embodiments of the present invention will now be described in greater detail. Nevertheless, it should be noted that the present invention can be practiced in a wide range of other embodiments besides those explicitly described, and the scope of the present invention is expressly not limited except as specified in the accompanying claims.

Moreover, some irrelevant details are not drawn in order to make the illustrations concise and to provide a clear description for easily understanding the present invention.

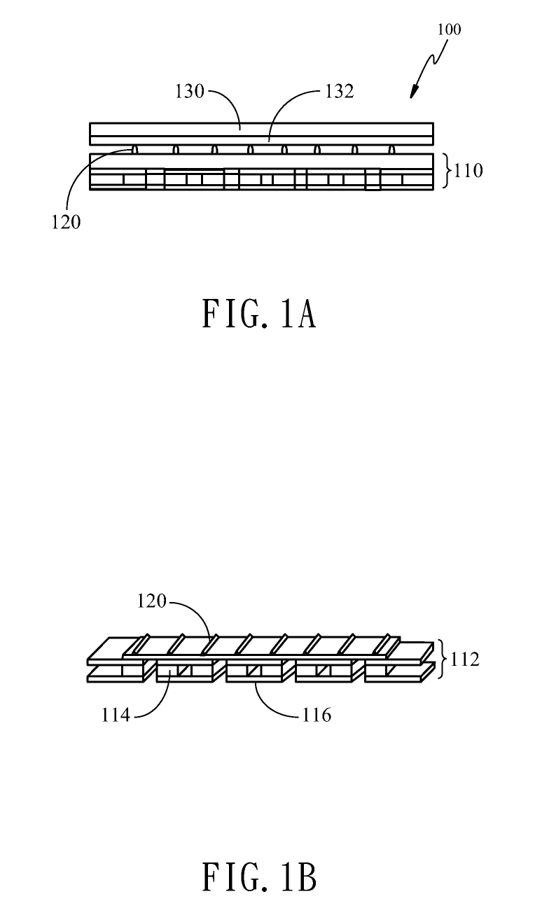

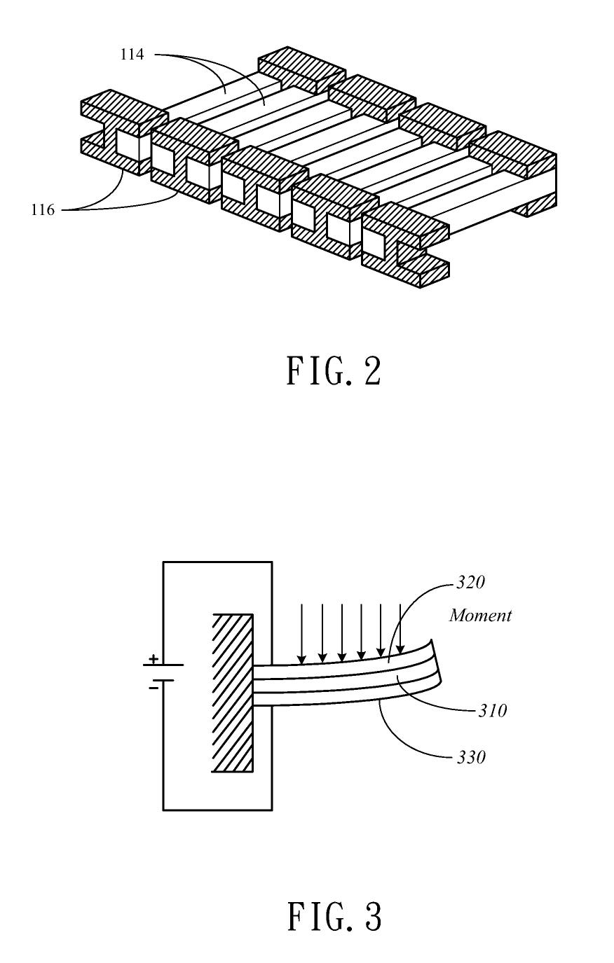

An exemplary structure 100 of the linear motor of one embodiment in accordance with the present invention is illustrated in FIG. 1A. The structure 100 comprises of a stator 110 and a carriage 130, which further comprises a coat of contact layer 132 contacting a gear teeth structure 120. The traveling wave generated by the stator 110 is transmitted to the carriage 130 to create a linear actuation application. The stator 110 of the piezoelectric linear motor structure 100 consisting of a meander-line structure 112 and a piece of gear teeth structure 120, in one example, made of elastic metal, is shown more detailed in FIG. 1B. A series of bimorph actuators 114 are laid in the meander line structure 112, and the neighboring bimorph actuators 114 forming a pair are linked with a corresponding connector 116 on both sides of top and bottom. Therefore the pairs of bimorph actuators 114 as well as their corresponding connector 116 could be grouped into odd and even, is illustrated in FIG. 2. Phase-splitter's AC current power is applied to the odd and the even actuators respectively, which generates traveling wave.

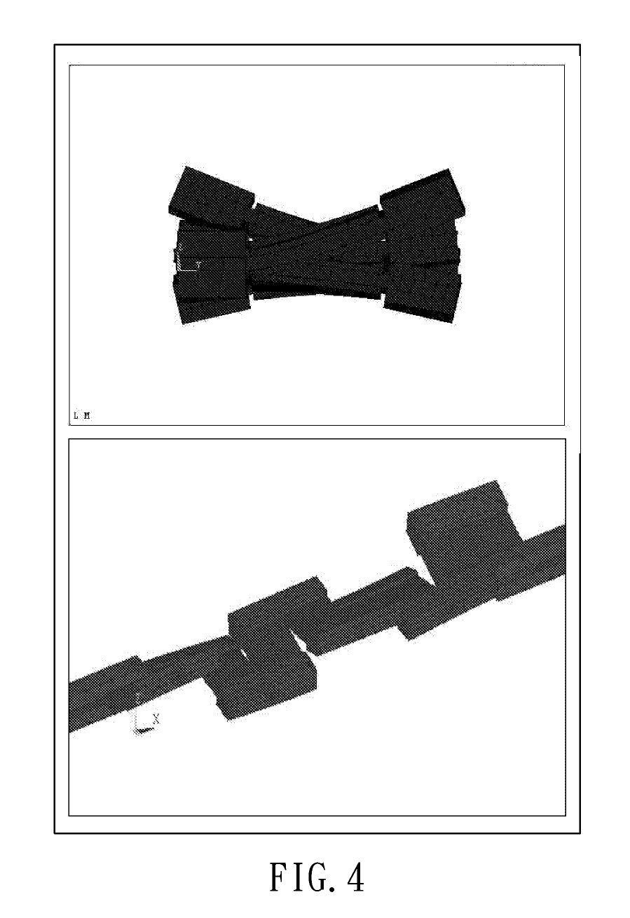

In FIG. 3, the bimorph actuator 114 is like a sandwich with a piece of metal 310 in the middle attached by two pieces of ceramics 320 and 330 on either side. Deformation occurs when the piezoelectric ceramics 320 and 330 are driven. Since the twist angles generated by the odd and even bimorph actuators 114 are almost approximately equivalent but opposite, the combined effect will keep the gear teeth 120 mounted above the meander-line structure 110 flat. In FIG. 4, both the side view and the top view of the meander-line structure 100 show that the deformation of each bimorph actuators 114 and connector 116 is approximately the same. Because of the equal bent-up and bent-down effect for the neighboring bimorph actuators 114 and connector 116, the plane in connection with the above gear teeth 120 thus keeps flat approximately.

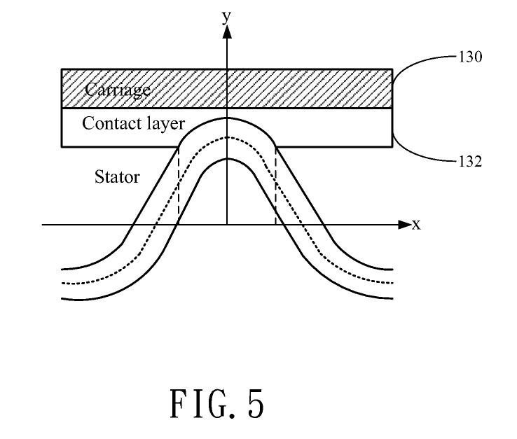

The gear teeth 120 made of elastic metal mounted on the meander-line structure 112 as shown in FIG. 2 is deformed synchronously with the bimorph actuators 114 and the connectors 116. With suitable compress force on the gear teeth 120, the elliptical motion of the surface particle of the stator 110 will move the carriage 130. Friction effect influential to the stator 110, the contact layer 132 and the carriage 130 is significant and studied as below. The wave transmission to the carriage 130 is presented in FIG. 5,

The designed linear motor makes use of the traveling wave generated by the stator 110. As illustrated in FIG. 1 the gear teeth 120 drives the above contact layer 132. Then, the energy is transferred to the carriage 130 by means of the friction between the medium contact layer 132 and the carriage 130. Power loss is inevitable because of friction and transmission. While the carriage 130 starts to move, according to Coulomb's friction law, two concepts are concerned with the following derivation.

It is assumed that non-sliding occurs between the stator 110 and the contact layer 132 as well as between the carriage 130 and the contact layer 132 before moving.

Although specific embodiments have been illustrated and described, it will be obvious to those skilled in the art that various modifications may be made without departing from what is intended to be limited solely by the appended claims.

What is claimed is:

1. A piezoelectric linear motor apparatus, comprising:
a carriage configured to be actuated; and
a stator configured to actuate the carriage, comprising:
a meander line structure comprising:
a series of bimorph actuators laid linearly in the meander line structure, wherein each pair of neighboring bimorph actuators being linked with a corresponding connector on both sides of top and bottom; and
an odd series of connectors and an even series of connectors, composed of all of said corresponding connectors and interleaved with each individual connector, applied with phase-splitter's alternating current (AC) power to deform the bimorph actuators for generating traveling wave; and
a gear teeth structure, coupled to the top of the meander line structure and a contact layer underneath the carriage, for transporting traveling wave from the meander line structure to the carriage.

2. The piezoelectric linear motor apparatus of claim 1, wherein the gear teeth structure is made of elastic metal.

3. The piezoelectric linear motor apparatus of claim 1, wherein the bimorph actuator further comprising a piece of metal attached by two pieces of piezoelectric ceramics on either side of the piece of metal.

4. The piezoelectric linear motor apparatus of claim 1, wherein the twist angles generated by the odd and even bimorph actuators are approximately equivalent but opposite.

5. The piezoelectric linear motor apparatus of claim 1, wherein a plane in connection with the above gear teeth structure keeps flat approximately since the equal bent-up and bent-down effect for the neighboring bimorph actuators and connector underneath the plane.

6. A piezoelectric linear motor apparatus, comprising:
a stator, comprising:
a meander line structure comprising:
a series of bimorph actuators laid linearly in the meander line structure, wherein each pair of neighboring bimorph actuators being linked with a corresponding connector on both sides of top and bottom; and
an odd series of connectors and an even series of connectors, composed of all of said corresponding connectors and interleaved with each individual connector.

7. The piezoelectric linear motor apparatus of claim 6, wherein said odd series of connectors and said even series of connectors are applied with phase-splitter's alternating current (AC) power to deform the bimorph actuators for generating traveling wave.

8. The piezoelectric linear motor apparatus of claim 6, further comprising:
a carriage configured to be actuated by said stator; wherein said stator configured further comprises a gear teeth structure, coupled to the top of the meander line structure and a contact layer underneath the carriage, for transporting traveling wave from the meander line structure to the carriage.

9. The piezoelectric linear motor apparatus of claim 6, wherein the gear teeth structure is made of elastic metal.

10. The piezoelectric linear motor apparatus of claim 6, wherein the bimorph actuator further comprising a piece of metal attached by two pieces of piezoelectric ceramics on either side of the piece of metal.

11. The piezoelectric linear motor apparatus of claim 6, wherein the twist angles generated by the odd and even bimorph actuators are approximately equivalent but opposite.

12. The piezoelectric linear motor apparatus of claim 6, wherein a plane in connection with the above gear teeth structure keeps flat approximately since the equal bent-up and bent-down effect for the neighboring bimorph actuators and connector underneath the plane.

13. A method for actuating a carriage, comprising:
providing a meander line structure coupled to a gear teeth structure underneath the carriage, wherein the meander line structure further comprising a series of bimorph actuators laid linearly in the meander line structure, wherein each pair of neighboring bimorph actuators being linked with a corresponding connector on both sides of top and bottom; and an odd series of connectors and an even series of connectors, composed of all of said corresponding connectors and interleaved with each individual connector;
deforming the bimorph actuators by applying phase-splitter's alternating current (AC) power to the odd and the even series of connectors;
transporting traveling waves, generated by the deforming, to the carriage via the gear teeth structure.

14. The method for actuating a carriage of claim 13, wherein the gear teeth structure is made of elastic metal.

15. The method for actuating a carriage of claim 13, wherein the bimorph actuator further comprising a piece of metal attached by two pieces of piezoelectric ceramics on either side of the piece of metal.

16. The method for actuating a carriage of claim 13, wherein the twist angles generated by the odd and even bimorph actuators are approximately equivalent but opposite.
